(19) United States
(12) Patent Application Publication
(10) Pub. No.: US 2014/0307950 A1
(43) Pub. Date: Oct. 16, 2014

(54) IMAGE DEBLURRING

(71) Applicant: MICROSOFT CORPORATION, Redmond, WA (US)

(72) Inventors: Jeremy Jancsary, Cambridge (GB); Uwe Johann Schmidt, Grosskrotzenburg (DE); Reinhard Sebastian Bernhard Nowozin, Cambridge (GB); Carsten Curt Eckard Rother, Cambridge (GB)

(73) Assignee: Microsoft Corporation, Redmond, WA (US)

(21) Appl. No.: 13/862,415

(22) Filed: Apr. 13, 2013

(51) Int. Cl. G06T 5/00; G06K 9/62

(52) U.S. Cl. CPC G06T 5/003; G06K 9/62
USPC 382/154; 382/155

(57) ABSTRACT

Image deblurring is described, for example, to remove blur from digital photographs captured at a handheld camera phone and which are blurred due to camera shake. In various embodiments an estimate of blur in an image is available from a blur estimator and a trained machine learning system is available to compute parameter values of a blur function from the blurred image. In various examples the blur function is obtained from a probability distribution relating a sharp image, a blurred image and a fixed blur estimate. For example, the machine learning system is a regression tree field trained using pairs of empirical sharp images and blurred images calculated from the empirical images using artificially generated blur kernels.

### BACKGROUND

Digital images taken with hand held digital cameras often show blur due to camera shake. For example, a person taking a photo of an indoor scene using a camera phone often finds the resulting photograph to be blurry. The camera typically detects lower light levels indoors and automatically sets a higher exposure time. As the person takes the photo the lightweight, hand held, camera may move during the exposure time because of hand shake or movement of the person and/or camera.

Previous approaches to automatically deblurring digital photographs are typically computationally expensive, slow and introduce artifacts. For example, so called “ringing” artifacts are often introduced where intensity values are inappropriately altered so that ghost-like effects appear around objects depicted in the image.

Previous approaches to automatically deblurring digital photographs have also found it difficult to cope with fine detail in images as well as regions with little texture. For example, smooth areas may be reconstructed at the expense of fine detail.

The embodiments described below are not limited to implementations which solve any or all of the disadvantages of known image deblurring processes.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Image deblurring is described, for example, to remove blur from digital photographs captured at a handheld camera phone and which are blurred due to camera shake. In various embodiments an estimate of blur in an image is available from a blur estimator and a trained machine learning system is available to compute parameter values of a blur function from the blurred image. In various examples the blur function is obtained from a probability distribution relating a sharp image, a blurred image and a fixed blur estimate. For example, the machine learning system is a regression tree field trained using pairs of empirical sharp images and blurred images calculated from the empirical images using artificially generated blur kernels.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a camera phone used to capture an image of a scene and of an image deblur engine used to deblur the captured image;

FIG. 2 is a schematic diagram of the image deblur engine of FIG. 1 in more detail;

FIG. 3 is a flow diagram of a method at the image deblur engine of FIG. 2;

FIG. 4 is a flow diagram of a method of synthetically generating blurred images for use as training data;

FIG. 5 is a flow diagram of a method of synthetically generating a blur kernel;

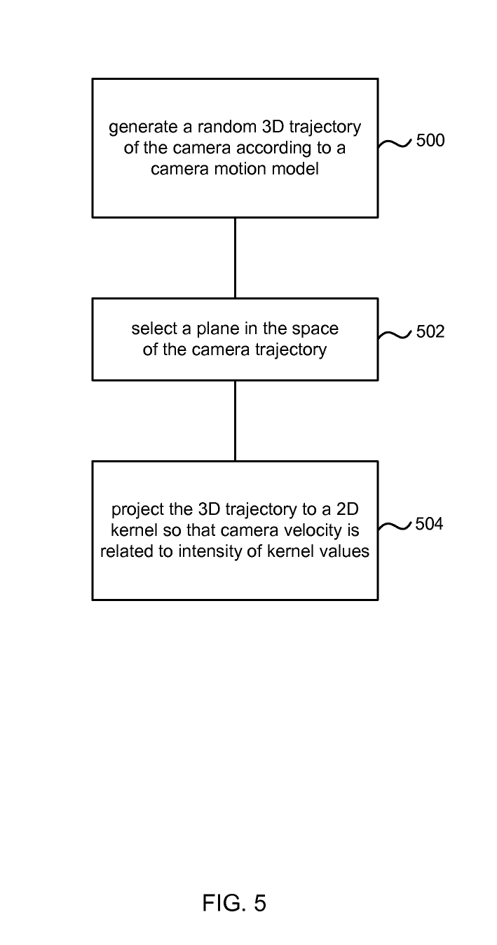

FIG. 6 is a flow diagram of a method of training a regression tree field;

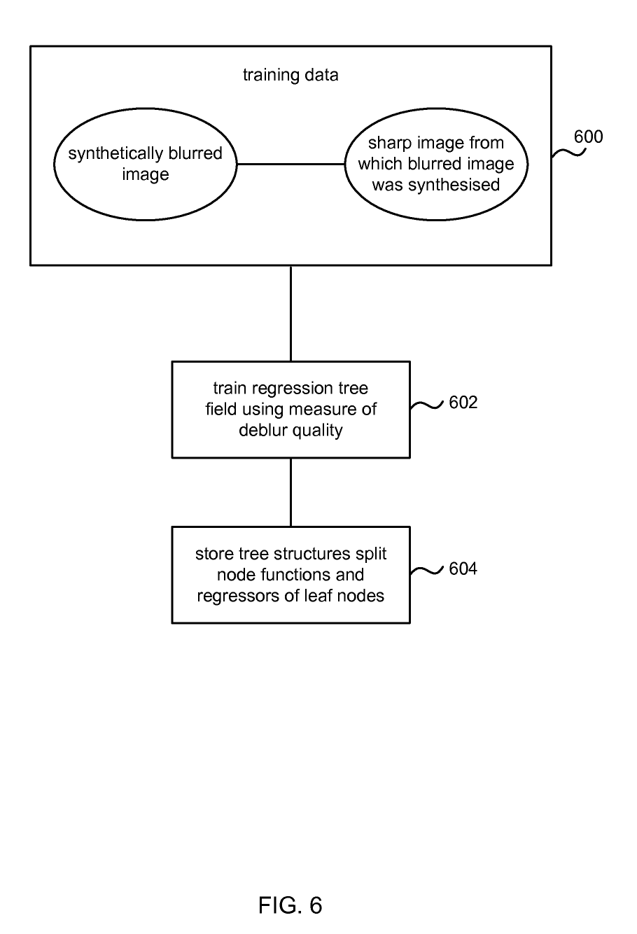

FIG. 7 illustrates an exemplary computing-based device in which embodiments of an image deblur engine may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a camera phone, the system described is provided as an example and not a limitation. As those skilled in the art will appreciate, the present examples are suitable for application in a variety of different types of image capture devices where image blur occurs including dedicated digital cameras, video cameras, medical image systems, traffic image systems, security imaging systems, satellite image systems and other imaging systems.

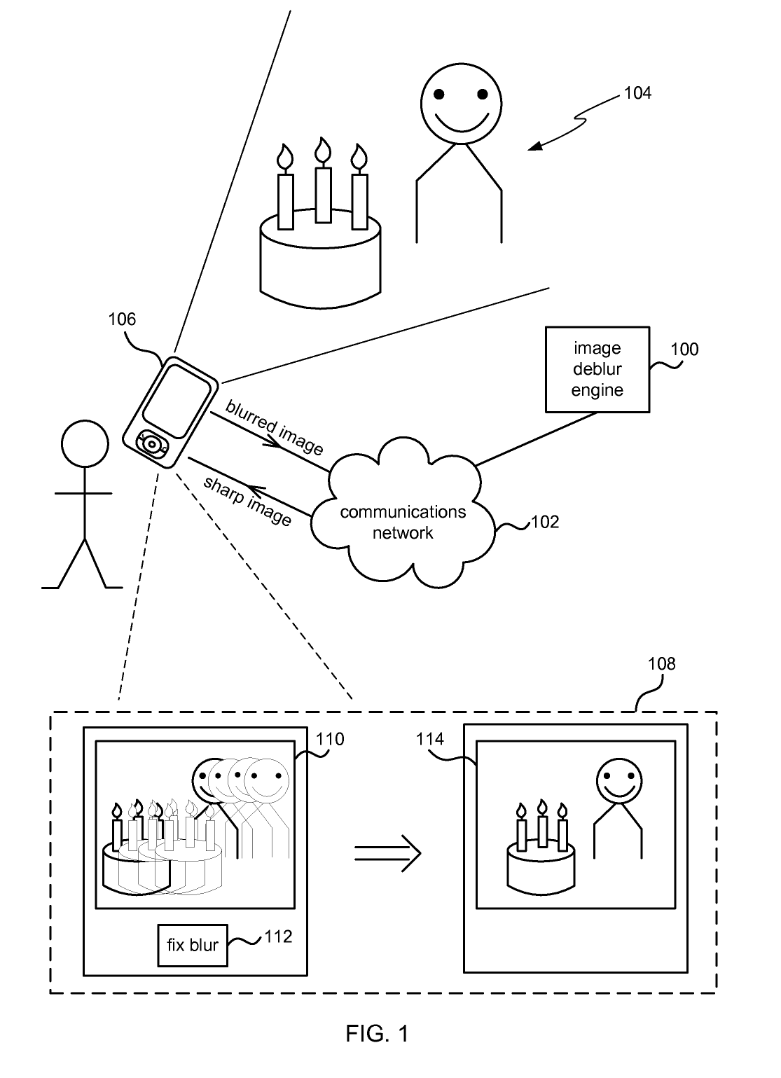

FIG. 1 is a schematic diagram of a camera phone 106 used to capture an image 110 of a scene 104 and of an image deblur engine 100 used to deblur the captured image. In this example the image deblur engine 100 is located in the cloud and is accessible to the camera phone 106 via a communications network 102 such as the interne or any other suitable communications network. However, it is also possible for the image deblur engine 100, in whole or in part, to be integral with the camera phone 106.

The camera phone 106 is held by a person (indicated schematically) to take a photograph of an indoor scene comprising a birthday cake and a child. Because the scene is indoor the light levels may be relatively low so that the camera phone 106 automatically sets a longer exposure time. As the person takes the digital photograph he or she shakes or moves the camera phone during the exposure time. This causes the captured image 110 to be blurred. A display 108 at the camera phone is indicated schematically in FIG. 1 and shows the blurred image 110 schematically. In practice the blur acts to smooth regions of the image so that fine detail is lost. A graphical user interface at the camera phone may display an option “fix blur” 112 or similar which may be selected by the user to generate a new version 114 of the blurred image in which the blur is removed. The new version 114 may be displayed at the camera phone.

In this example the camera phone sends the blurred image 110 to an image deblur engine 110 which is in communication with the camera phone over a communications network 102. The image deblur engine 100 calculates a sharp image from the blurred image and returns the sharp image to the camera phone 106. The images may be compressed prior to sending in order to reduce the amount of communications bandwidth; and decompressed when received.

In this example the image blur is due to camera shake. However, other forms of image blur may also be addressed with the image deblur engine. For example, blur arising from parts of the image that are not in focus, referred to as out-of-focus blur.

The image deblur engine 100 is computer implemented using software and/or hardware. It may comprise one or more graphics processing units or other parallel processing units arranged to perform parallel processing of image elements.

For example, the functionality of the image deblur engine described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs).

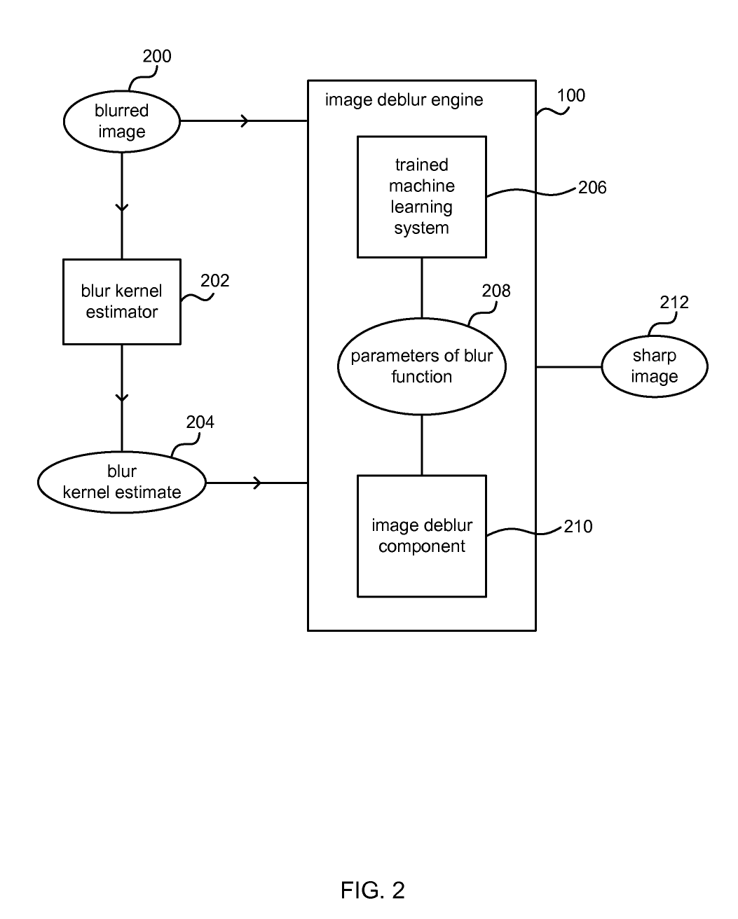

More detail about the image deblur engine 100 is now given with respect to FIG. 2. The image deblur engine 100 has an input to receive a blurred image 200 (in compressed or uncompressed form) and also to receive a blur kernel estimate 204. The blurred image 200 may be the blurred image 110 or any other digital image comprising blur due to camera motion during exposure time.

A blur kernel is a 2D array of numerical values which may be convolved with an image in order to create blur in that image. Convolution is a process whereby each image element is updated so that it is the result of a weighted summation of neighboring image elements. The set of neighboring image elements and the weight of each image element are specified in a kernel. The kernel may be stored as a 2D array or in other formats. The center of the kernel is aligned with each image element so that the aligned weights stored in the kernel can be multiplied with the image elements. Given a blurred image 200 a blur kernel estimator 202 is able to compute an estimate of a blur kernel 204 which describes at least part of the blur present in the blurred image 200. For example, this may include blur due to camera shake and/or out-of-focus blur. Other parts of the blur due to noise or other factors may not be described by the blur kernel. Any suitable computer-implemented blur kernel estimator 202 may be used. For example, as described in any of the following publications: Cho et al. “Fast motion deblurring” ACM T. Graphics, 28, 2009; Fergus et al. “Removing camera shake from a single photograph.” ACM T. Graphics, 3(25), 2006; Levin et al. “Efficient marginal likelihood optimization in blind deconvolution” CVPR 2011; Xu et al. “Two-phase kernel estimation for robust motion deblurring”, ECCV 2010.

The image deblur engine 100 comprises a trained machine learning system 206 which is arranged to take as input the blurred image 200 (and/or features computed from the blurred image 200) and to produce predicted values of parameters 208 of a blur function, optionally with certainty information about the predicted values.

The blur function may be the result of using point estimation with a probability distribution expressing the probability of a sharp image given a blurred form of the sharp image and a fixed blur kernel estimate. The fixed blur kernel estimate expresses or describes an estimate of the blur applied to the sharp image to obtain the blurred image. In various examples the blur function is expressed as a Gaussian conditional random field (CRF) as follows:

p(x|y,K)

Which may be expressed in words as: the probability of sharp image x given blurred input image y and a fixed blur matrix K (expressing the blur kernel). The blur matrix K (which is different from the blur kernel) is a matrix of size N by N where N is the number of image elements. It may be formed from the blur kernel by placing the blur kernel around each image element and expressing the weighted summation as a matrix-vector multiplication (each row of the blur matrix corresponds to one application of the blur kernel). By multiplying the image x with the blur matrix K the image is convolved with the blur kernel; that is the convolution is expressed as matrix-vector multiplication. A conditional random field (CRF) is a statistical model for predicting a label of an image element by taking into account other image elements in the image. A Gaussian conditional random field comprises unary potentials and pair-wise potentials.

An optimizer of the blur function may be expressed as being related to the fixed blur matrix K and to parameters (matrices Θ and θ in the example below) which are functions of the input image y. For example,

arg maxₓp(x|y,K)=(Θ(y)+αK^{T}K)⁻¹(θ(y)+αK^{T}y)

Which may be expressed in words as, the sharp image x which gives the optimal probability under the model given input blurry image y and input blur matrix K is equal to the product of: the inverse of, parameter values Θ regressed from the input blurry image y plus a scalar based on the noise level of the input blurry image times a transpose of the blur matrix K times itself; and parameter values θ regressed from the blurry input image y plus a scalar based on the noise level of the input blurry image times a transpose of the blur matrix K applied to the input blurry image.

Once the values of the parameters Θ and θ 208 are available from the trained machine learning system they may be input to an image deblur component 210. This component is computer implemented and it inputs the values of the parameters Θ and θ to the above expression of the blur function. It computes a sharp image 212 by solving the expression as a sparse linear system. The sharp image 212 may be displayed, stored or sent to another entity.

The machine learning system 206 may comprise a trained regression tree field (RTF), a plurality of trained regression tree fields, or any other suitable trained regressor(s).

A regression tree field is a plurality of regression trees used to represent a conditional random field. For example, one or more regression trees may be associated with unary potentials of a conditional random field and one or more regression trees may be associated with pairwise potentials of a conditional random field. Unary potentials are related to individual image elements. Pair-wise potentials are related to pairs of image elements. Each leaf of the regression tree may store an individual linear regressor that determines a local potential.

A regression tree comprises a root node connected to a plurality of leaf nodes via one or more layers of split nodes. Image elements of an image may be pushed through a regression tree from the root to a leaf node in a process whereby a decision is made at each split node. The decision is made according to characteristics of the image element and characteristics of test image elements displaced therefrom by spatial offsets specified by the parameters at the split node. At a split node the image element proceeds to the next level of the tree down a branch chosen according to the results of the decision. During training, image statistics (also referred to as features) are chosen for use at the split nodes and parameters are stored at the leaf nodes. For example, components of the parameters Θ and θ, describing the local potentials, are assumed to be stored at the leaf nodes in various examples described herein. These parameters are then chosen so as to optimize the quality of the predictions (as measured by a loss function) on the training set. After training, image elements and/or features of an input blurry image are pushed through the regression trees to find values of the parameters Θ and θ of the blur function suited for the particular blurry image.

Regression tree fields are described in U.S. patent application Ser. No. 13/337,324 “Regression Tree Fields” filed on 27 Dec. 2011. Regression tree fields are also described in Jancsary et al. “Regression tree fields—an efficient, non-parametric approach to image labeling problems” CVPR 2012.

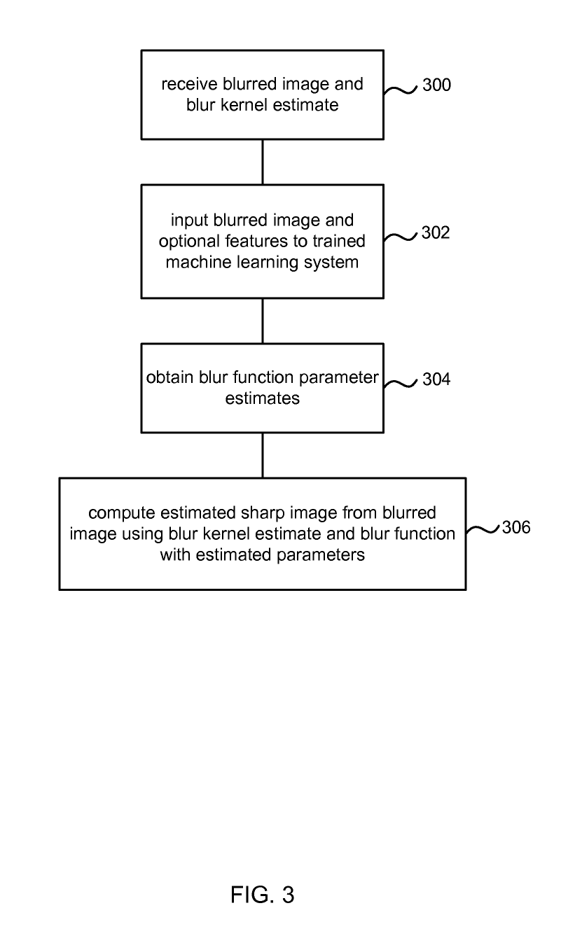

FIG. 3 is a flow diagram of a method at the image deblur engine 100. A blurred image is received 300 together with a blur kernel estimate. Image elements and/or features computed from the blurred image are input 302 to the trained machine learning system to obtain 304 blur function parameter estimates. An estimated sharp image is then computed 306 from the blurred image using the blur function described above with the estimated parameter values and with the fixed blur kernel.

In order to train the machine learning system 206 training data comprising pairs of corresponding sharp and blurred images are used which are appropriate for blur introduced by camera motion during exposure time. Blur kernel data is also available. Large amounts of training data are needed to achieve good quality deblur functionality. However, this type of training data is difficult to obtain for natural, empirical images rather than for synthetically generated images. For example one option is to use laboratory multi-camera arrangements to record real camera motions and the resulting blurred images. However, this is time consuming, expensive and does not result in natural digital photographs typically taken by end users.

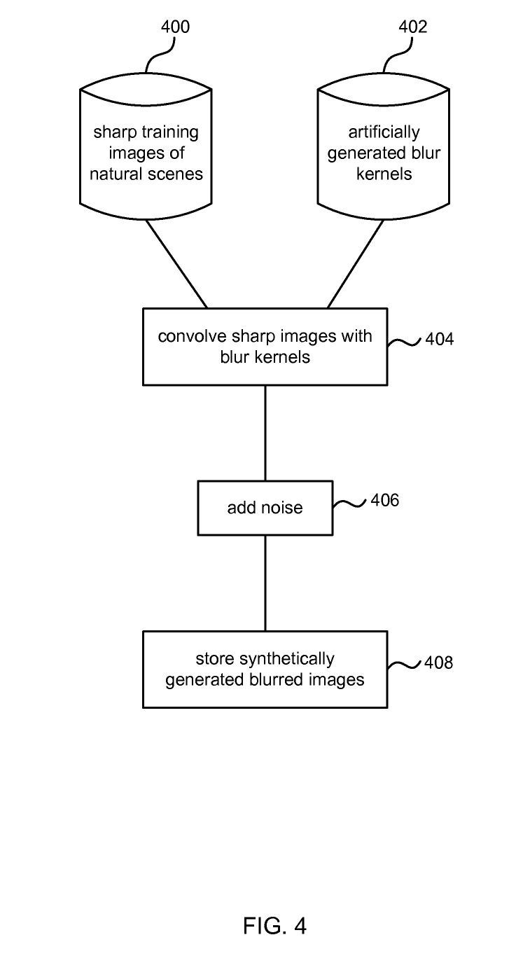

In some examples, training data is obtained by artificially generating blur kernels and applying these to sharp natural images as now described with reference to FIG. 4. A database 400 or other store of sharp training images of natural scenes is accessed. A store 402 of artificially generated blur kernels is also available. The sharp images are convolved 404 with the blur kernels and noise may be added 406 to the resulting image. The resulting synthetically generated blurred images are stored 408 for use in training.

As mentioned above a blur kernel is a 2D array of numerical values which may be convolved with an image in order to create blur in that image. The blur kernel may describe the motion of the camera during the exposure time. For example, values in the blur kernel may represent a velocity (speed and direction) of the camera during the exposure time. One or more models of camera motion may be available, such as linear motion, random motion, or others. To artificially generate blur kernels for use in the method of FIG. 4 a random 3D trajectory may be generated 500 to represent camera motion, according to a selected one of the camera motion models. A plane may be selected 502 in the space of the generated camera trajectory and the 3D trajectory may be projected 504 to a 2D kernel region of that plane. In this way a kernel is created where the kernel values are related to the camera velocity.

By artificially generating blur kernels in this way it has been found that large amounts of realistic blurred images may be generated from natural sharp images for training. In this way the resulting trained machine learning system is able to generalize well; that is, it is able to produce good predictions for blurry input images which are dissimilar to those used during training.

Once large numbers of natural sharp images and blurred versions of those sharp images 600 are available for training, the machine learning system is trained 602 using a measure of deblur quality. Any suitable measure of deblur quality may be used. For example, peak signal to noise ratio (PSNR), mean squared error (MSE), mean absolute deviation (MAD), or structural image similarity (SSIM). Split functions in the regression trees and linear regressors at the leaves of the regression trees may be selected according to peak signal to noise ratio or any other measure of deblur quality. The structures of the trained regression trees, the split node functions and the regressors of the leaf nodes may be stored 604 either at the image deblur engine or at another entity.

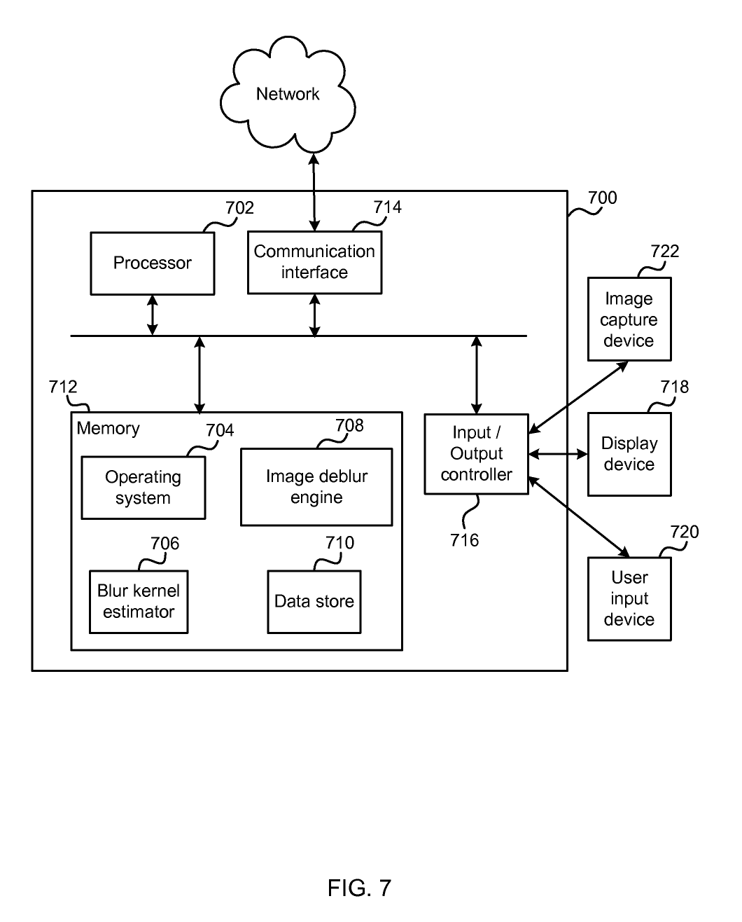

FIG. 7 illustrates various components of an exemplary computing-based device 700 which may be implemented as any form of a computing and/or electronic device, and in which embodiments of an image deblur engine or an image capture device incorporating an image deblur engine may be implemented.

Computing-based device 700 comprises one or more processors 702 which may be microprocessors, controllers or any other suitable type of processors for processing computer executable instructions to control the operation of the device in order to calculate a sharp image from a blurred image and a blur kernel estimate. One or more of the processors may comprise a graphics processing unit or other parallel computing unit arranged to perform operations on image elements in parallel. In some examples, for example where a system on a chip architecture is used, the processors 702 may include one or more fixed function blocks (also referred to as accelerators) which implement a part of the method of image deblurring in hardware (rather than software or firmware).

Platform software comprising an operating system 704 or any other suitable platform software may be provided at the computing-based device to enable software implementing an image deblur engine 705 or at least part of the image deblur engine described herein to be executed on the device. Software implementing a blur kernel estimator 706 is present in some embodiments. It is also possible for the device to access a blur kernel estimator from another entity such as by using communication interface 714. A data store 710 at memory 712 may store training data, images, parameter values, blur kernels, or other data.

The computer executable instructions may be provided using any computer-readable media that is accessible by computing based device 700. Computer-readable media may include, for example, computer storage media such as memory 712 and communications media. Computer storage media, such as memory 712, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 712) is shown within the computing-based device 700 it will be appreciated that the storage may be distributed or located remotely and accessed via a network or other communication link (e.g. using communication interface 714).

The computing-based device 700 also comprises an input/output controller 716 arranged to output display information to a display device 718 which may be separate from or integral to the computing-based device 700. The display information may provide a graphical user interface which may display blurred images and deblurred images and icons such as the “fix blur” icon of FIG. 1. The input/output controller 716 is also arranged to receive and process input from one or more devices, such as a user input device 720 (e.g. a mouse, keyboard, camera, microphone or other sensor). In some examples the user input device 720 may detect voice input, user gestures or other user actions and may provide a natural user interface (NUI). This user input may be used to indicate when deblurring is to be applied to an image, to select deblurred images to be stored, to view images and for other purposes. In an embodiment the display device 718 may also act as the user input device 720 if it is a touch sensitive display device. The input/output controller 716 may also output data to devices other than the display device, e.g. a locally connected printing device.

Any of the input/output controller 716, display device 718 and the user input device 720 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, rgb camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method of deblurring an image comprising:
receiving, at a processor, a blurred image;
accessing an estimate of blur present in the blurred image;
applying at least part of the blurred image to a trained machine learning system to calculate a plurality of values of parameters of a blur function which relates a sharp image to a blurred image and a blur estimate;
calculating a sharp image from the blurred image using the values, the blur function and the blur estimate.

2. A method as claimed in claim 1 the blurred image having been captured using an image capture device which moved during exposure time.

3. A method as claimed in claim 1 where the estimate of blur comprises a kernel having a plurality of numerical values.

4. A method as claimed in claim 1 comprising applying at least part of the blurred image to a trained machine learning system having been trained using pairs of empirical sharp images and blurred images calculated from the empirical sharp images.

5. A method as claimed in claim 1 comprising applying at least part of the blurred image to a trained machine learning system having been trained using pairs of empirical sharp images and blurred images calculated from the empirical sharp images using artificially generated blur kernels.

6. A method as claimed in claim 1 where the trained machine learning system comprises a regression tree field.

7. A method as claimed in claim 1 where the trained machine learning system comprises a regression tree field comprising a plurality of regression trees where each leaf stores an individual linear regressor related to a local potential.

8. A method as claimed in claim 1 where the blur function is the result of using point estimation with a probability distribution expressing the probability of a sharp image given a blurred form of the sharp image and a fixed blur kernel estimate.

9. A method as claimed in claim 1 comprising training the machine learning system using pairs of empirical sharp images and blurred images calculated from the empirical sharp images using artificially generated blur kernels.

10. A method as claimed in claim 9 comprising generating the blur kernels by generating a 3D trajectory of a camera and projecting the 3D trajectory to a 2D kernel.

11. A method as claimed in claim 9 comprising using a model of camera motion to generate the 3D trajectory.

12. A method of deblurring an image comprising:
displaying a blurred image;
receiving, at a processor, user input indicating blur in the image is to be removed;
accessing an estimate of blur present in the blurred image;
calculating a sharp image from the blurred image using a trained machine learning system and the blur estimate; and
displaying the calculated sharp image.

13. A method as claimed in claim 12 comprising receiving the blurred image from a camera at a hand held device.

14. A method as claimed in claim 12 comprising applying at least part of the blurred image to the trained machine learning system to calculate a plurality of values of parameters of a blur function which relates a sharp image to a blurred image and a blur estimate.

15. An image deblur engine comprising:
a processor arranged to receive a blurred image;
the processor being arranged to access an estimate of blur present in the blurred image;
a trained machine learning system arranged to apply at least part of the blurred image to calculate a plurality of values of parameters of a blur function which relates a sharp image to a blurred image and a blur estimate;
the processor arranged to calculate a sharp image from the blurred image using the values, the blur function and the blur estimate.

16. An image deblur engine as claimed in claim 15 the trained machine learning system having been trained using pairs of empirical sharp images and blurred images calculated from the empirical sharp images using artificially generated blur kernels.

17. An image deblur engine as claimed in claim 15 where the trained machine learning system comprises a regression tree field.

18. An image deblur engine as claimed in claim 15 where the trained machine learning system comprises a regression tree field comprising a plurality of regression trees where each leaf stores an individual linear regressor related to a local potential.

19. An image deblur engine as claimed in claim 15 where the blur function is obtained from a probability distribution expressing the probability of a sharp image given a blurred form of the sharp image and a fixed blur kernel estimate.

20. An image deblur engine as claimed in claim 15 which is at least partially implemented using hardware logic selected from any one or more of: a field-programmable gate array, a program-specific integrated circuit, a program-specific standard product, a system-on-a-chip, a complex programmable logic device, a graphics processing unit.
